(19) United States
(12) Patent Application Publication
(10) Pub. No.: US 2013/0294302 A1
(43) Pub. Date: Nov. 7, 2013

(54) Broadband Antenna and Radio Base Station System for Process-ing at Least Two Frequency Bands or Radio Standards in a Radio Communications System

(71) Applicants: Wilhelm Hermann Hofmann, (US); Lucia Agnes Hofmann, Heidenheim an der Brenz (DE)

(72) Inventors: Ralf Dieter Hofmann, Heidenheim (DE); Martin Goldberg, Greifenberg (DE); Elmar Guha, Ulm-Lehr (DE); Andree Haubrich, Blaubeuren (DE); Helmut Heinz, Turkheim (DE); Risto Kaarlo Saukkonen, Oulu (FI)

(73) Assignee: NOKIA SIEMENS NETWORKS OY, ESPOO (FI)

(21) Appl. No.: 13/813,442

(22) PCT Filed: Aug. 1, 2011
(86) PCT No.: PCT/EP11/63191

§ 371 Date: Jul. 11, 2013

(30) Foreign Application Priority Data
Aug. 4, 2010 (CN) 201010246605.0
Aug. 4, 2010 (CN) 201020283170.2

(51) Int. Cl. H04L 5/08

(52) U.S. Cl. CPC H04L 5/08
USPC 370/297

(57) ABSTRACT

The present invention refers to a broadband antenna configured for processing at least two frequency bands or radio standards in a radio communications system, the broadband antenna including at least one column, the column including at least one antenna element, a first phase shifter configured for phase shifting a first frequency band or radio standard and a second phase shifter configured for phase shifting a second frequency band or radio standard, and a diplexer configured for diplexing the phase shifted first and second frequency bands or radio standards, including two inputs and one output, with the first phase shifter and the second phase shifter being coupled to the two inputs, and the antenna element being coupled to the output. The invention further refers to a radio base station system including a broadband antenna according to the invention.

### FIELD OF THE INVENTION

The present invention relates to processing at least two frequency bands or radio standards in a radio communications system. Particularly, the present invention refers to a broadband antenna configured to perform said processing at least two frequency bands or radio standards in a radio communications system, and an according radio base station system comprising a broadband antenna configured to perform said processing at least two frequency bands or radio standards in a radio communications system.

### BACKGROUND OF THE INVENTION

Mobile radio base station antennas represent the radio frequency (RF) access points in a radio communications system, realizing the connection to mobile phones via the air interface. While generally, in a radio communications system, different frequency bands are used by the locally available wireless radio standards, it is desired that mobile radio base station antennas are optimized to the relevant frequency band or radio standard to provide good RF properties. Furthermore, the optimum vertical electrical tilt of the antenna beam, achieved by phase shifting of the signal, depends on the actual frequency band and radio standard used for radio transmissions by the respective antenna. For mobile radio base station sites with many different frequency bands and/or radio standards, the amount of required antennas today is high, and it is often not possible to mount all antennas to one antenna site due to site engineering, legal or commercial constraints. With the introduction of new radio standards and release of new frequency bands, this situation will even become worse.

To reduce the number of required antennas, broadband antennas have been introduced recently. They support a large bandwidth and therefore cover different frequency bands or radio standards within one antenna. However, known broadband antennas only provide means to adjust one common vertical tilt for the whole antenna which has the negative effect that frequency band radio standard optimized tilting cannot be assured. If different tilting is required, separate antennas dedicated to every standard are required.

Thus, there is still a need for improved mobile radio base station antennas.

### SUMMARY OF THE INVENTION

Object of the present invention is to provide an improved broadband antenna and radio base station system for processing at least two frequency bands or radio standards in a radio communications system, which overcome the above mentioned problems.

This object is achieved by a broadband antenna comprising features according to claims 1 and 3, and a radio base station comprising features according to claim 6.

Further embodiments of the present invention are provided with the corresponding dependent claims.

The object of the present invention is achieved by a broadband antenna configured for processing at least two frequency bands in a radio communications system, the broadband antenna comprising at least one column. The column comprises at least one antenna element, a first phase shifter configured for phase shifting a first frequency band and a second phase shifter configured for phase shifting a second frequency band, and a diplexer configured for diplexing the phase shifted first and second frequency bands, comprising a first input, a second input, and one output. The first phase shifter is coupled to the first input, the second phase shifter is coupled to the second input, and the antenna element is coupled to the output.

According to embodiments of the present invention, the antenna element is a polarized antenna element, and each frequency band comprises a first polarization direction and a second polarization direction. Furthermore, said first phase shifter is a dual phase shifter configured for phase shifting the first polarization direction and the second polarization direction of the first frequency band, and said second phase shifter is a dual phase shifter configured for phase shifting the first polarization direction and the second polarization direction of the second frequency band. The diplexer is a dual diplexer, comprising two single diplexers, each single diplexer comprising a first input, a second input, and one output. The first phase shifter is coupled to the first inputs, the second phase shifter is coupled to the second inputs, and the antenna element is coupled to the outputs.

The object of the present invention is also achieved by a broadband antenna configured for processing at least two radio standards in a radio communications system, the broadband antenna comprising at least one column. The column comprises at least one antenna element, a first phase shifter configured for phase shifting a first radio standard and a second phase shifter configured for phase shifting a second radio standard, and a diplexer configured for diplexing the phase shifted first and second radio standards, comprising a first input, a second input, and one output. The first phase shifter is coupled to the first input, the second phase shifter is coupled to the second input, and the antenna element is coupled to the output.

According to embodiments of the present invention, the antenna element is a polarized antenna element, and each radio standard comprises a first polarization direction and a second polarization direction. Furthermore, said first phase shifter is a dual phase shifter configured for phase shifting the first polarization direction and the second polarization direction of the first radio standard, and said second phase shifter is a dual phase shifter configured for phase shifting the first polarization direction and the second polarization direction of the second radio standard. The diplexer is a dual diplexer, comprising two single diplexers, each single diplexer comprising a first input, a second input, and one output. The first phase shifter is coupled to the first inputs, the second phase shifter is coupled to the second inputs, and the antenna element is coupled to the outputs.

According to embodiments of the present invention, the diplexer is a printed circuit board diplexer.

According to further embodiments of the present invention, the broadband antenna further comprises a printed wiring board, said printed wiring board comprising said printed circuit board diplexer.

According to further embodiments of the present invention, the broadband antenna further comprises a housing, said housing comprising the antenna element, the first and second phase shifters, and the diplexer.

The object of the present invention is also achieved by a radio base station system, comprising a broadband antenna according to the invention.

### BRIEF DESCRIPTION OF THE DRAWINGS

The present invention will be more clearly understood from the following description of the preferred embodiments of the invention read in conjunction with the attached drawings, in which:

FIG. 1 shows a broadband antenna according to some embodiments of the present invention;

FIG. 2 shows a broadband antenna according to some embodiments of the present invention; and

FIG. 3 shows a radio base station system according to some embodiments of the present invention.

### DESCRIPTION OF THE PREFERRED EMBODIMENTS

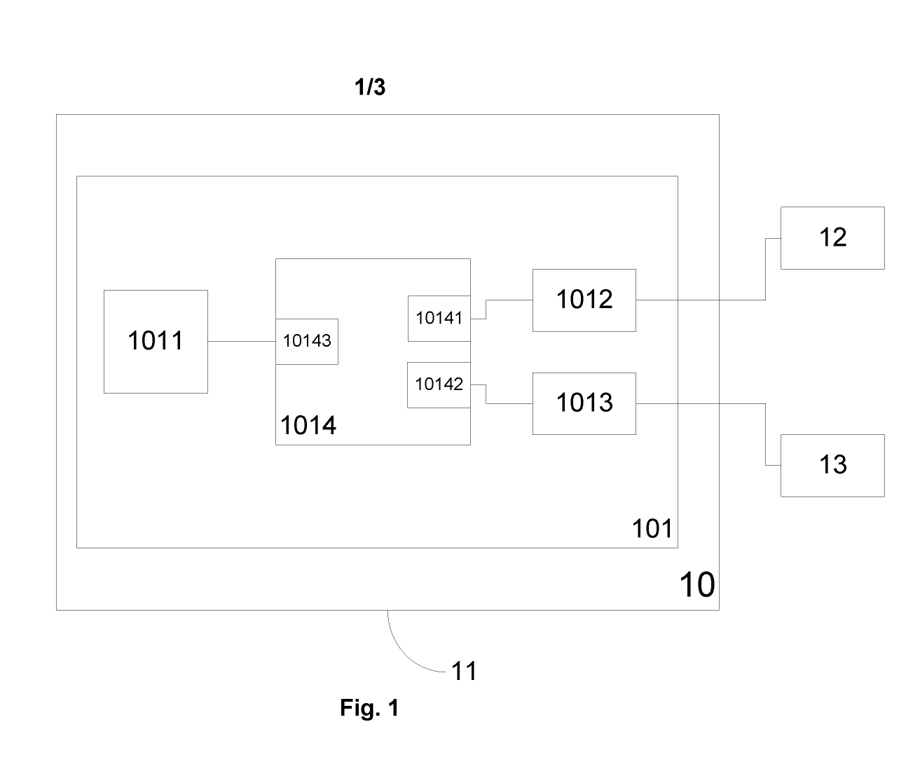

FIG. 1 shows a broadband antenna according to some embodiments of the present invention.

The broadband antenna 10 is configured for processing two frequency bands 12, 13 in a radio communications system. However, the same principle can be applied also for three or more frequency bands or radio standards. The broadband antenna 10 shown in FIG. 1 comprises one column 101. The column 101 comprises an antenna element 1011. While, for reasons of simplicity, the example antenna shown in FIG. 1 has only one column and one antenna element, it should be apparent to those skilled in the art that the invention also works for more than one column and more than one antenna element comprised in each column.

The broadband antenna 10 comprises a housing 11. The housing 11 comprises the antenna element 1011, the first and second phase shifters 1012, 1013, and the diplexer 1014.

The broadband antenna 10 further comprises a first phase shifter 1012 configured for phase shifting a first frequency band 12 and a second phase shifter 1013 configured for phase shifting a second frequency band 13.

Furthermore, the broadband antenna 10 comprises a diplexer 1014 configured for diplexing the phase shifted first and second frequency bands. The diplexer 1014 comprises a first input 10141, a second input 10142, and one output 10143, wherein the first phase shifter 1012 is coupled to the first input 10141, the second phase shifter 1013 is coupled to the second input 10142, and the antenna element 1011 is coupled to the output 10143.

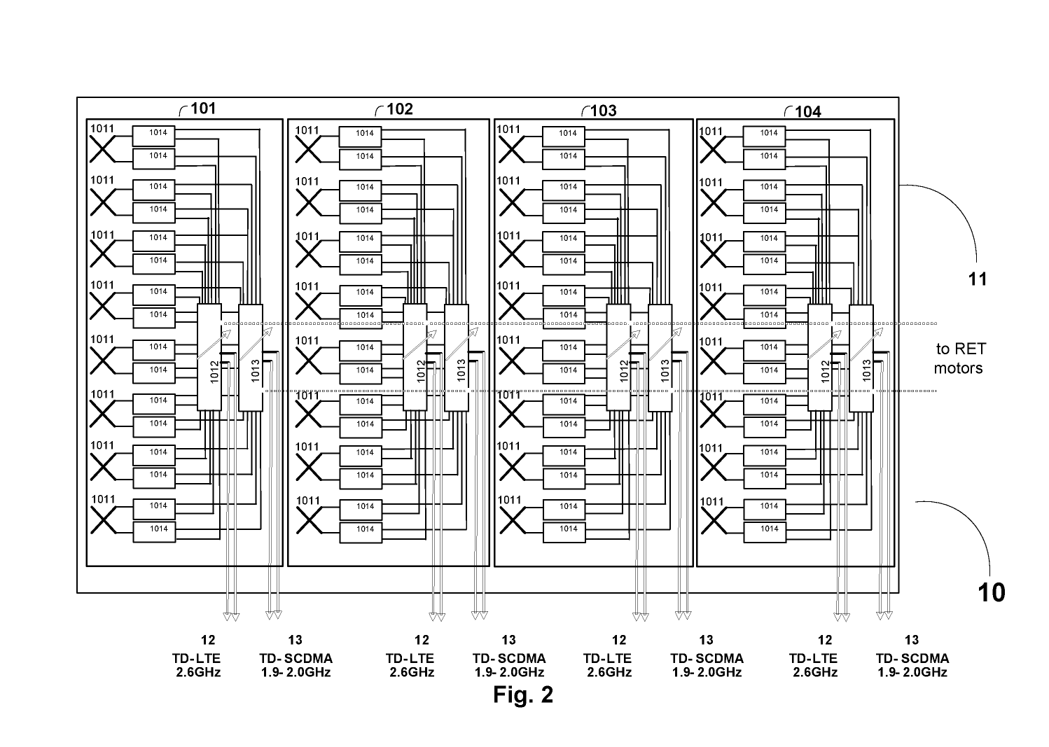

FIG. 2 shows a broadband antenna 10 according to some embodiments of the present invention. In particular, FIG. 2 shows an example embodiment regarding a solution for a broadband antenna 10 comprising four columns 101, 102, 103, 104, supporting two frequency bands. In the shown embodiment, the first frequency band 12 is a TD-LTE frequency band on 2.6 GHz, and the second frequency band 13 is a TD-SCDMA frequency band on 1.9-2.0 GHz. However, any combination of frequency bands and/or radio standards is possible, e.g.

GSM as radio standard, and two frequency bands, one band tilted with a first, lower angle, and a second band tilted with a second, higher angle, for covering different cell areas;

GSM as a first radio standard, LTE as a second radio standard, but the same frequency band; or

GSM as a first radio standard, LTE as a second radio standard, and two frequency bands, one band tilted with a first, lower angle, and a second band tilted with a second, higher angle, for covering different cell areas.

As stated above, the invention is not restricted to four columns broadband antennas, but is also applicable for one column and more columns broadband antennas.

As in the case of the example shown in FIG. 2, typically two polarization directions are transmitted per column 101, 102, 103, 104, and therefore cross polarized antenna elements 1011, or radiators, are used.

The main elements for the band independent vertical tilting are the phase shifters 1012, 1013 and the diplexers 1014 between phase shifters 1012, 1013 and antenna elements 1011. The phase shifters 1012, 1013 are controlled either electro-mechanically, e.g. by motors, in particular stepper motors, or fully electronically. The phase shifters 1012, 1013 are part of a RF feeder network which terminates on the one side at the antenna connector of the antenna 10 and on the other side at the diplexers 1014/antenna elements 1011. For each polarization direction per column 101, 102, 103, 104 and frequency band 12, 13, one phase shifter 1012, 1013 is required. In FIG. 2, for simplicity reasons, only a first phase shifter 1012 and a second phase shifter 1013 are shown. However, it is clear for the person skilled in the art that for the situation depicted in FIG. 2, two first phase shifters 1012 and two second phase shifters 1013 are necessary, due to the two polarization directions of the frequency bands 12, 13. In some cases the same phase shift can be used for both polarization directions, and in this case only one first phase shifter and one second phase shifter are required.

For simplicity reasons, in FIG. 2 the diplexer inputs 10141, 10142 and output 10143 are omitted.

One diplexer 1014 is required for each polarization direction per column 101, 102, 103, 104 and antenna element 1011/antenna element group 1011 (all antenna elements within this group are fed with the same RF signal regarding amplitude and phase).

According to some embodiments of the invention, one motor controls the phase shifters 1012, 1013 of one frequency band 12, 13.

According to further embodiments of the invention, one motor controls the phase shifter 1012, 1013 of one polarization direction of one frequency band 12, 13 and thus enables polarization independent tilting per band.

According to some embodiments of the invention, the diplexers 1014 are implemented as printed circuits on the antenna printed wiring board (PWB), so that no external diplexers are required and the volume and/or weight of the antenna will be optimized.

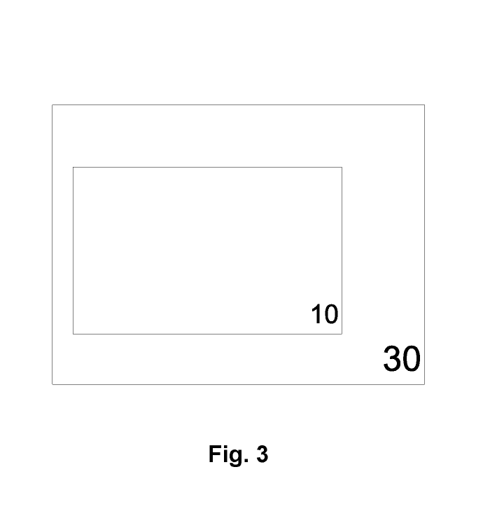

FIG. 3 shows a radio base station system 30, comprising a broadband antenna 10 according to the present invention.

The invention proposes a solution which allows frequency band independent tilt adjustment of at least two frequency bands or radio standards and thus enables more compact site engineering and less boxes at the antenna mast/tower pole.

In particular, if the broadband antenna supports two different radio standards on two different frequency bands, the invention allows to tilt a first radio standard A to get a larger coverage, and to tilt a second radio standard B for capacity optimization.

While embodiments and applications of this invention have been shown and described above, it should be apparent to those skilled in the art, that many more modifications (than mentioned above) are possible without departing from the inventive concept described herein. The invention, therefore, is not restricted except in the spirit of the appending claims. Therefore, it is intended that the foregoing detailed description should be regarded as illustrative rather than limiting.

### LIST OF ABBREVIATIONS

GSM Global System for Mobile communication
LTE Long Term Evolution
PWB Printed Wiring Board
RF Radio Frequency
TD-LTE Time Division LTE
TD-SCDMA Time Division Synchronous Code Division Multiple Access

### LIST OF REFERENCES

10 broadband antenna
11 housing
12 first frequency band
13 second frequency band
101, 102,
103, 104 column
1011 antenna element
1012 first phase shifter
1013 second phase shifter
1014 diplexer
10141 diplexer input
10142 diplexer input
10143 diplexer output
30 radio base station system

1. Broadband antenna configured for processing at least two frequency bands in a radio communications sys-tern, the broadband antenna comprising at least one column, the column comprising
at least one antenna element;
a first phase shifter configured for phase shifting a first frequency band and a second phase shifter configured for phase shifting a second frequency band;
a diplexer configured for diplexing the phase shifted first and second frequency bands, comprising a first input, a second input, and one output, wherein the first phase shifter is coupled to the first input, the second phase shifter is coupled to the second input, and the antenna element is coupled to the output.

2. Broadband antenna according to claim 1, wherein the antenna element is a polarized antenna element, and wherein each frequency band comprises a first polarization direction and a second polarization direction, and wherein
said first phase shifter is a dual phase shifter configured for phase shifting the first polarization direction and the second polarization direction of the first frequency band;
said second phase shifter is a dual phase shifter configured for phase shifting the first polarization direction and the second polarization direction of the second frequency band;
and wherein said diplexer is a dual diplexer, comprising two single diplexers, each single diplexer comprising a first input, a second input, and one output, wherein the first phase shifter is coupled to the first inputs, the second phase shifter is coupled to the second inputs, and the antenna element is coupled to the outputs.

3. Broadband antenna configured for processing at least two radio standards in a radio communications system, the broadband antenna comprising at least one column, the column comprising
at least one antenna element;
a first phase shifter configured for phase shifting a first radio standard and a second phase shifter configured for phase shifting a second radio standard;
a diplexer configured for diplexing the phase shifted first and second radio standards, comprising a first input, a second input, and one output, wherein the first phase shifter is coupled to the first input, the second phase shifter is coupled to the second input, and the antenna element is coupled to the output.

4. Broadband antenna according to claim 3, wherein the antenna element is a polarized antenna element, and wherein each radio standard comprises a first polarization direction and a second polarization direction, and wherein
said first phase shifter is a dual phase shifter configured for phase shifting the first polarization direction and the second polarization direction of the first radio standard;
said second phase shifter is a dual phase shifter configured for phase shifting the first polarization direction and the second polarization direction of the second radio standard;
and wherein said diplexer is a dual diplexer, comprising two single diplexers, each single diplexer comprising a first input, a second input and one output, wherein the first phase shifter is coupled to the first inputs, the second phase shifter is coupled to the second inputs, and the antenna element is coupled to the outputs.

5. Broadband antenna according to claim 1, wherein said diplexer is a printed circuit board diplexer.

6. Broadband antenna according to any preceding claim claim 1, the broadband antenna further comprising a printed wiring board, said printed wiring board comprising said printed circuit board diplexer.

7. Broadband antenna according to claim 1, the broadband antenna further comprising a housing, said housing comprising the antenna element, the first and second phase shifters, and the diplexer.

8. Radio base station system, comprising a broadband antenna according to claim 1.
